(19) United States
(12) Patent Application Publication
(10) Pub. No.: US 2015/0120435 A1
(43) Pub. Date: Apr. 30, 2015

(54) METHOD AND SYSTEM OF CONTROL OF FLOW OF CUSTOMERS AND TECHNICAL RESOURCES

(71) Applicant: BANQUE ACCORD, Croix (FR)

(72) Inventor: Benoit Ferlin, Hallennes-Lez-Haubourdin (FR)

(73) Assignee: BANQUE ACCORD, Croix (FR)

(21) Appl. No.: 14/123,270

(22) PCT Filed: May 23, 2013
(86) PCT No.: PCT/FR2013/051133

§ 371 Date: Apr. 10, 2014

(30) Foreign Application Priority Data
May 25, 2012 (FR) 12 54864

(51) Int. Cl. G06Q 30/02

(52) U.S. Cl. CPC G06Q 30/0276; G06Q 30/0268
USPC 705/14.43; 705/14.65; 705/14.51

(57) ABSTRACT

Method of processing information for generating a promotional means (2) granting a commercial benefit to a customer at a point of sale, said method comprising a step of programming a value of the promotional means as a function of at least one technical constraint (3-5) related to said point of sale.

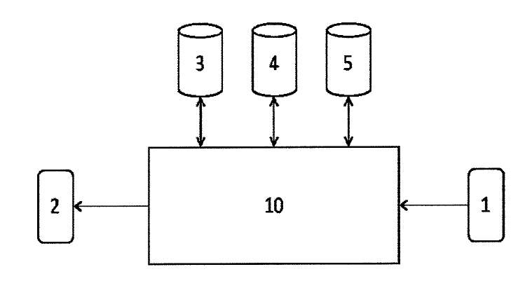

The present invention relates to a method of managing promotional techniques for controlling flows of customers and technical resources needed in a promotional operation. It also relates to a cash register system and a computer program product implementing said method.

Hereinafter, the phrase “promotional techniques” is understood as being the different techniques based on promotional means for granting a temporary commercial benefit to a customer, such as coupons or discount vouchers.

Indeed, over a predefined period of time (called promotion), promotional means are sent to/offered to customers, giving them the right to a discount, credit note, refund or free gift on an immediate or subsequent purchase.

In general, said promotional means are to stimulate short-term demand, resulting in a net increase in sales and traffic during the promotion period.

However, and in spite of the commercial benefit they can contribute, promotional techniques are generally sources of technical malfunctions. Indeed, the setup of a promotion necessitates the mobilization and allocation of multiple technical resources throughout the duration of the promotion for managing flows of customers and/or product(s)/service(s) being promoted.

These technical difficulties are manifested by additional needs, with respect to capacities in terms of technical resources, of the point of sale prior to the promotional operation (additional technical devices are required, for example, for transport/receiving, storage/inventory, presentation/display, resupply, sale (cash registers, computers, or servers/bandwidth in the case of e-commerce for example), the delivery of the product/service being promoted).

In particular, other technical difficulties occur at the end of the promotion period, generally marked by a significant decrease in sales because of the subsequent effects of the promotional techniques. Consequently, the technical resources must be readjusted accordingly (means of storage, display, delivery, servers, bandwidth for example).

An object of the present invention is to remedy the aforementioned disadvantages.

Another object of the present invention is to manage the control of the technical resources required for the implementation of a promotional operation.

Another object of the present invention is to reduce the subsequent technical effect of the promotional techniques.

To that end, according to a first aspect, the invention relates to a method of processing information for generating a promotional means granting a commercial benefit to a customer at a point of sale, said method comprising a step of programming a value of the promotional means as a function of at least one technical constraint related to said point of sale.

According to a second aspect, the invention relates to a system of processing information for generating a promotional means granting a commercial benefit to a customer at a point of sale, said system comprising a generator configured for programming a value of the promotional means as a function of at least one technical constraint related to said point of sale.

According to a third aspect, the invention relates to a cash register system integrating the system summarized above.

According to a fourth aspect, the invention relates to a computer program product implemented on a storage medium, capable of being run on an electronic data processing unit and comprising instructions for the implementation of the method summarized above.

Other characteristics and advantages of the invention will appear more clearly and in more detail from the following description of preferred embodiments, provided with reference to the appended figure, which illustrates a non-limiting functional representation of a generator of promotional means according to one embodiment.

Represented in the figure is a generator 10 of a promotional means 2 on behalf of an identifier 1, while taking into account technical constraints 3-5 related to a point of sale. Of course, a point of sale can be an online sales site (an e-commerce site), a department store, boutique, small grocery store, supermarket, superstore, shopping center, or more generally a real or virtual sales place/space.

Indeed, the generator 10 of promotional means 2 is configured to program the value (i.e., the actual commercial benefit), over time, of the promotional means 2 based on the technical constraints 3-5 that reflect any technical factor that could promote/hinder the promotional operation.

The identifier 1 is any data making it possible to designate one or more customer(s) or one or more potential customer(s) such as a customer number, an email address, a postal address, a telephone number, a zip code (to designate a set of customers), a last name/first name, an age range, gender (male/female), working hours (administrative hours, nighttime hours for example), status (retired or not), a purchase amount already paid or to be paid, frequency of visits to the point of sale, number of items, number of customer loyalty points, a promotion code for example.

In one embodiment, the identifier 1 is provided to the generator 10 at the time of payment of the purchase of item(s) at the point of sale. Said identifier 1 can be, in particular, recovered from a customer loyalty card, cash receipt, payment card, prospectus (barcode), chip card, gift card, or more generally from information furnished in advance by the customer during a registration step (online or in store) at the point of sale (email address, zip code, last name/first name, age, gender for example).

As a variant, a specific identifier 1 of one or more potential customer(s) (for example, gender (male/female), zip code, status (retired or not)) can be furnished to the generator 10 in order to generate the promotional means 2 intended to be distributed to this(these) customer(s).

As a variant or in combination, the identifier 1 can be any data (for example barcode, brand name, manufacturer, origin, version, range, category, volume) making it possible to designate one or more product(s) and/or service(s), or one or more class(es) of product(s) and/or service(s) offered by the point of sale (for example home appliances, food products, destinations/lengths of stay).

In particular, the identifier 1 can be a combination of a first data item relating to one or more customer(s), and a second data item relating to one or more product(s)/service(s) offered by the point of sale.

Supplying the identifier 1 triggers the issuance by the generator 10 of a promotional means 3 [sic: 2], the duration of validity and value of which (percentage discount, free gift, refund, or a credit in a monetary unit) take into account the technical constraints 3-5 related to the point of sale.

For example, the technical constraints 3-5 include without limitation,
the capacities 3 of the point of sale in terms
   of surface area and of technical means (for example media, means of packaging, means of presentation and display) available at the point of sale for the display and/or presentation of the product/service concerned by the promotional operation, as well as other product(s)/service(s) (particularly equivalent products/services);
   of available storage space and means;
   of management of the flow of customers (number of cash registers for example) or connections (for example servers, allocated bandwidth) in the case of an online point of sale;
   of logistical means, receiving, resupply, and delivery of the product(s)/service(s) concerned by the promotional operation;
of descriptive and/or predictive models 4 concerning the customers, based on a recent history of customer flows, such as
   distribution over time (for example by day, week, month, event: celebrations/vacations/holidays) of the flows of customers at that point of sale;
   the geographic distribution of the customers (for example based on their zip codes, postal addresses, or IP addresses in the case of an online point of sale);
   the distribution of the customers based on their statuses (for example retired or not)
descriptive and/or predictive models 5 concerning the product/service that is the object of the promotional means 2, such as
   statistical data (average, variance, distributions) concerning the sales (by unit of time, by customer zip codes) outside the promotion periods of the product/service in question;
   statistical data (average, variance, distributions) concerning the sales of product(s)/service(s) that are equivalent/similar/concurrent to the product/service in question, outside of and/or during the promotion period of the latter.

In one embodiment, user preferences (furnished during a registration step, or in response to a request issued at the time of payment for a purchase by the online point of sale) are taken into account by the promotional means generator 10. For example, a plurality of alternate promotional means 2, having respective values, durations or relating to different products/services, can be offered to a customer.

The promotional means generator 10 is provided with calculation means configured to resolve problems of optimization with or without constraints (for example multidimensional optimization, regression, neural networks) in order to take into account the technical constraints 3-5.

The promotional means 2 issued by the generator 10 as a function of the technical constraints 3-5, on behalf of the identifier 1, can be
sent to the customer identified by the identifier 1 (for example by email, SMS, regular mail);
stored in a memory zone included in a customer loyalty card, chip card, or electronic payment means available to the customer;
printed immediately at the cash register on the back of the cash receipt;
printed and distributed to the customer(s) and/or potential customer(s).

Advantageously, the promotional means generator 10 is configured to be integrated into any computerized cash register system. Consequently,
the identifier 1 can be automatically furnished to the genitor [sic: generator] 10 by the computerized cash register system; and
the promotional means 2 (i.e., the commercial benefit) generated by the generator 10 can be immediately taken into account by the computerized cash register system.

In one embodiment, by furnishing a predefined identifier 1 (for example, the total amount of a purchase, the number of a customer, or the barcode of a product) to the promotional means generator 10, the computerized cash register system obtains in return the commercial benefit (i.e., the current value of the promotional means 2) to be applied to the transaction in progress.

In one illustrative example of implementation of the method and system described above, during checkout between a first date and a second date of a customer to pay for the purchase of item(s), the promotional means generator 10 is programmed to generate to that customer, designated by a certain identifier 1, a promotional means 2,
the value of which decreases linearly over time starting from a certain value (if it is expressed in monetary unit) or 100% (if it
[is] expressed in percentage) until it reaches the value of zero in order to avoid the subsequent effect of the promotional operation. The technical effect of this is that the average sale of the promotion product/service at the end of the promotion period returns smoothly to the average sale value 5 for this product prior to the promotion. In particular, this responds to a capacity constraint 3 that the point of sale must confront in the event the promotional means loses its value overnight, causing a drop in the average sales of the product/service that is no longer in promotion;
the value is constant, up to a specific date, during non-business days and zero during business days (particularly Saturdays). In other words, the value is not zero on many occasions over time. The technical effect of this is to regulate the number of connections and transactions (considered important, from descriptive models 4, during non-business days) for an online point of sale having limited technical capacities 3 (means of delivery and network resources: bandwidth, servers) (otherwise, the saturation of the servers during a promotional operation could certainly have a counterproductive effect);
the value has a limited distribution over time, in inverse proportion to a predictive model 4 of the flow of customers in order to better manage limited technical resources 3 (number of cash registers, means of exposure for example).

The promotional means 2 comprises, for example, the date of its emission, its initial value, the end date of its validity, the law of variation of its value, a (value_i, date_i) vector, an identifier of the product/service concerned by the promotion, an identifier of the customer, an identifier of a geographic zone, an identifier of the point of sale. These examples are obviously not limiting because other information such as legal or financial information can be included in the promotional means 2.

When a promotional means 2 or any other means comprising said promotional means 2 is presented to a cash register system, the cash register system is programmed to read or determine (for example in

relation to the current date, or in relation to the identifier 1) the value of the promotional means 2 and take it into account.

It should be noted that the term “generator” includes here any physical device incorporating a programmed processor to provide one or more predetermined functions, or any software application (program or subprogram, plug-in) implemented on a processor, independently or in combination with other applications with other software applications [sic].

1. Method of processing information for generating a promotional means granting a commercial benefit to a customer at a point of sale, said method comprising a step of programming a value of the promotional means as a function of at least one technical constraint related to said point of sale.

2. Method according to claim 1, wherein the value of the promotional means is not zero on multiple occasions.

3. Method according to claim 1, wherein the value of the promotional means decreases linearly over time.

4. Method according to claim 1, wherein the technical constraint is the capacity in terms of storage, display, or delivery of the point of sale.

5. Method according to claim 1, wherein the constraint is a model of the flow of customers.

6. Method according to claim 1, wherein the point of sale is an online point of sale.

7. Method according to claim 6, wherein the technical constraint is the number of connections to said online point of sale.

8. Method according to claim 1, further comprising a step of supplying an identifier on behalf of which the promotional means is generated.

9. System of processing information for generating a promotional means granting a commercial benefit to a customer at a point of sale, said system comprising a generator configured for programming a value of the promotional means as a function of at least one technical constraint related to said point of sale.

10. System according to claim 9, characterized in that said generator comprises calculation means configured to resolve an optimization problem with at least one constraint.

11. Cash register system comprising a processing system according to claim 9.

12. Cash register system according to claim 11, configured to determine at least one value of a promotional means generated by the processing system.

13. Computer program product implemented on a storage medium, capable of being run on an electronic data processing unit and comprising instructions for the implementation of a method of processing information according to claim 1.
